(19) United States
(12) Patent Application Publication
(10) Pub. No.: US 2006/0049306 A1
(43) Pub. Date: Mar. 9, 2006

(54) Rear wing structure for remote-controlled flight assuring fast and stable turning

(76) Inventors: Seung-Woo Kim, Daejon (KR); Il-Hyung Jang, Daejon (KR)

Correspondence Address: IPLA P.A., 3580 WILSHIRE BLVD., 17TH FLOOR, LOS ANGELES, CA, 90010, US

(21) Appl. No.: 10/545,366

(22) PCT Filed: Feb. 9, 2004
(86) PCT No.: PCT/KR04/00249

§ 371 Date: Aug. 11, 2005

(30) Foreign Application Priority Data
Feb. 21, 2003 (KR) 1020030011005

(51) Int. Cl. B64C 33/02

(52) U.S. Cl. 244/72

(57) ABSTRACT

The present invention provides a horizontal rear wing structure of a remote controlled flight assuring fast and stable turning. The horizontal rear wing structure 1000 includes a servomotor facing the upper side of the flight body D, a rotating member 220 mounted on the servomotor and a connecting part 300 mounted on the top side of the rotating member, the connecting part being combined with the horizontal rear wing. Accordingly, the horizontal rear wing 400 rotates with respect to the plane of the flight body.

### FIELD OF THE INVENTION

The present invention relates to a rear wing structure for remote-controlled flight assuring fast and stable turning. The present invention shows an ornithopter type flight, however, the invention is not limited thereto.

### BACKGROUND

There is an ornithopter type flight. This type of flight includes the right and left main wings which are connected with an electrical motor through a connecting rod and gear train so that the operation of the motor causes the flapping motion of the right and left main wings. The flapping motion generates a thrust and a lift and the flight can fly. This type of flight needs a horizontal rear wing to obtain a necessary lift. When the horizontal rear wing is adjusted to be raised, the vertical component of the reaction due to the flapping motion of the main wings acts as the lift.

This type of flight may achieve its turning by means of a vertical rear wing. The rotation of the vertical rear wing to the right or left direction leads to the turning of the flight to the right or left direction. Alternatively, the generation of an unbalanced moment on the rear wing reacted against its progressive direction with respect to the central axis of the body leads to the turning of the flight to the right or left direction.

FIG. 1 shows a rear wing structure 100 of a conventional ornithopter type flight for turning the flight.

As shown, a panel 50 is provided within the body and a servo motor 10 for adjusting the altitude of the flight is mounted on the panel 50. A holder 201 for a servo motor 20 for adjusting the turning of the flight is connected to the rear part of the panel 50 by a hinge 203 and the holder 201 is linked to a rotating member 11 mounted on a rotating shaft of the servo motor 10 through a connecting rod 12. Also, a horizontal rear wing 40 is mounted on a rotating shaft of the servo motor 20 in the holder 201.

When the servo motor 20 for adjusting the turning of the flight operates, the horizontal rear wing 40 rotates with respect to the rotating shaft of the servo motor 20 (as indicated in the arrow direction T). Also, when the servo motor 10 for adjusting the altitude of the flight operates, the holder 201 swings with respect to the hinge 203 on the rear part of the panel 50 by the link movement of the connecting rod 12 and, accordingly, the horizontal rear wing 40 is moved upwardly or downwardly. (as indicated in the arrow direction H)

When the horizontal rear wing 40 rotates on rotating shaft of the servo motor 20 for adjusting the turning of the flight, there occurs unbalance of area on the horizontal rear wing 40 with respect to the central axis S of the body. Then, drag against the horizontal rear wing 40 is unbalanced with respect to the central axis S of the body and the moment reacted on the horizontal rear wing 40 is changed with respect to the central axis S of the body. As a result, the flight turns.

According to the operation of the servo motor 10 for adjusting the altitude of the flight, the degree of raise of the horizontal rear wing 40 changes and, accordingly, the drag area reacted on the horizontal rear wing 40 changes. This change of the drag area leads to the change of drag, which changes the angles of attack of the body and main wings. As a result, the altitude of the flight changes.

In the conventional horizontal rear wing structure 100, if the horizontal rear wing 40 rotates for the turning of the flight (as indicated in the arrow direction T), it substantially causes the reduction of the drag area on the horizontal rear wing 40 and results in the reduction of the angle of attack, which leads to the falling of the altitude at the same time. Accordingly, turning the flight while the altitude is kept requires simultaneous control of the servo motors 10 and 20, which requires very experienced control skill.

Therefore, in an ornithopter type flight controlled by the remote controller, a horizontal rear wing structure by which a novice can easily and stably control the flight is demanded.

### SUMMARY OF THE INVENTION

The present invention satisfies the above demand. The purpose of the present invention is to provide a horizontal rear wing structure of a remote-controlled flight by which a novice can easily and stably control its turning. According to the present invention, turning speed of a flight is very fast and, accordingly, the falling of the altitude of the flight during its turning is very minimal so that the stable turning is possible without control of the altitude. After all, the present invention provides a horizontal rear wing structure of a remote-controlled flight assuring fast and stable turning.

A remote controlled flight according to the present invention comprises a panel provided within a body of the flight, a servo motor mounted on the panel, a horizontal rear wing, and a connection for plane-rotation arranged between the servo motor and the horizontal rear wing for rotating the horizontal rear wing with respect to the plane of the body according to the operation of the servo motor.

Preferably, the connection for plane-rotation comprises a rotating member mounted on the servo motor facing the upper side of the body, and a connecting part mounted on the top side of the rotating member, the connecting part being combined with the horizontal rear wing.

In this case, the servo motor is arranged to face the upper side of the body in the rear part of the panel and the rotating member is directly mounted on a rotating shaft of the servo motor. Preferably, the connecting part comprises a combination portion with the horizontal rear wing to be combined with the horizontal rear wing, a combination portion with the rotating member to be combined with the rotating member, and a connecting portion connecting the combination portion with the horizontal rear wing and combination portion with the rotating member. In this case, the combination portion with the horizontal rear wing is angled upwardly as it progresses to the rearward so that the horizontal rear wing combined is raised upwardly.

Preferably, the remote controlled flight further comprises a holder for the servo motor, a first connection including a hinged connection portion and a fixing screw hole, the first connection combined with the holder for the servo motor, and a second connection combined with the panel, the second connection being hinged to the first connection on the hinged connection portion of the first connection and including corresponding screw holes formed along a track of the fixing screw hole generated when the first connection circles with respect to the hinged connection portion.

In the embodiment of the present invention, the remote controlled flight is an ornithopter type flight.

### BRIEF EXPLANATION OF DRAWINGS

FIG. 1 is a view showing a rear wing structure of a conventional ornithopter type flight for turning the flight;

FIG. 2 is a view showing a horizontal rear wing structure according to the present invention;

FIG. 3 is a view showing the rotation of the horizontal rear wing with respect to plane of the flight body;

FIG. 4 is a view showing the turning of the flight according to the present invention; and

FIG. 5 is a view comparing the present invention with the conventional art.

### DETAILD EXPLANATION OF PREFERRED EMBODIMENT

Now, the present invention will be explained with reference to the accompanying drawings.

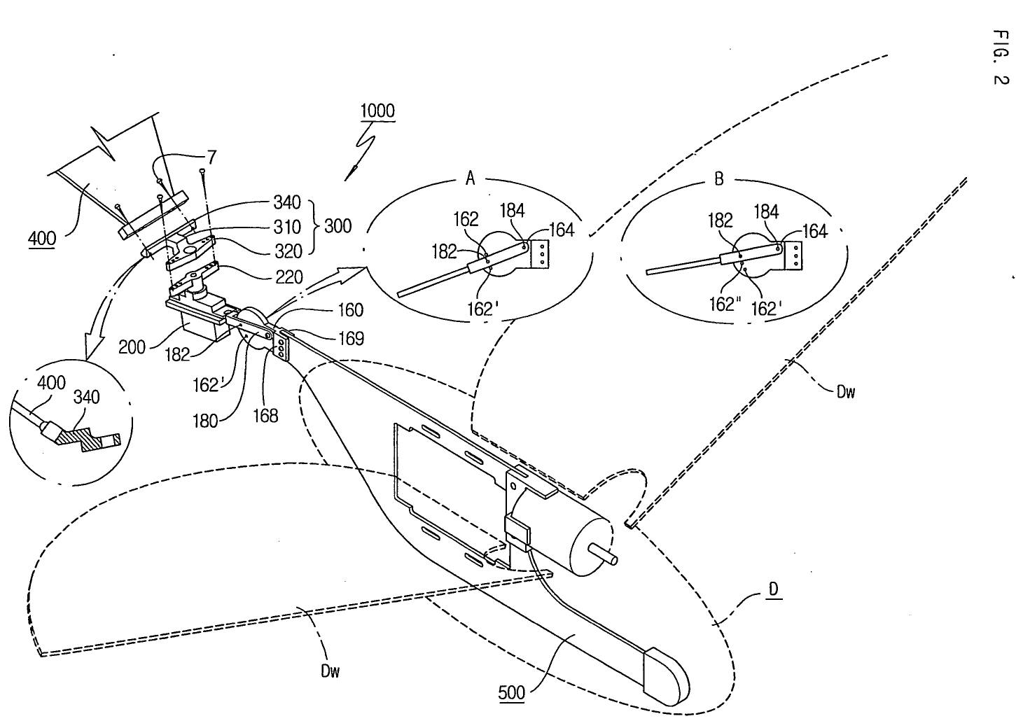

FIG. 2 shows a horizontal rear wing structure 1000 of an remote-controlled flight according to the present invention.

Firstly, within a body D having the right and left main wings Dw, panel 500 is provided and a servo motor holder 200 is combined with the panel 500 in the rear part of the panel 500.

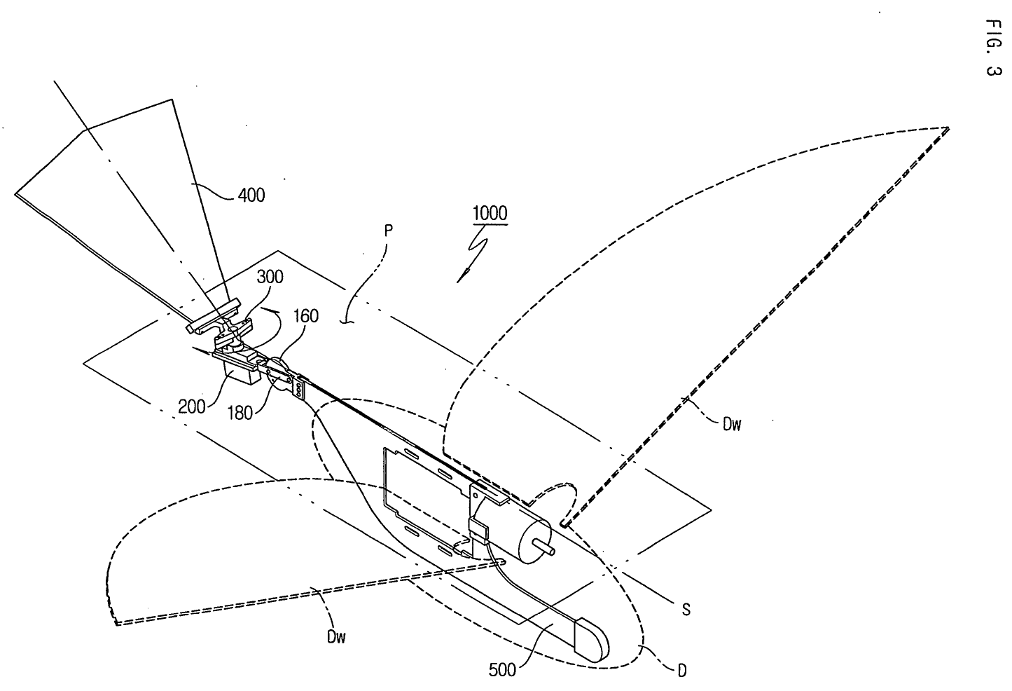

A horizontal rear wing 400 is connected with the servo motor in the holder 200 by means of a connection for plane-rotation so that the horizontal rear wing 400 rotates with respect to the plane (P in FIG. 3) of the body.

The connection for plane-rotation includes a rotating member 220 mounted on the rotating shaft of the servo motor in the holder 200 and a connecting part 300 which connects the rotating member 220 with the horizontal rear wing 400.

The rotating member 220 is arranged to face the upper side of the body and the connecting part 300 is mounted on the top side of the rotating member 220. In this embodiment, the servo motor is arranged in the holder 200 to face the upper side of the body D and the rotating member 220 is directly mounted on the rotating shaft of the servo motor.

The connecting part 300 includes combination portion 340 to be combined with the horizontal rear wing 400. The combination portion 340 is combined with the horizontal rear wing 400 by means of screws as shown. Also, the connecting part 300 includes combination portion 320 to be combined with the rotating member 220. The combination portion 320 is combined with the rotating member 220 by means of screws as shown.

The combination portions 320 and 340 of the connecting part 300 are connected by a connecting portion 310.

Especially, the combination portion 340 for the horizontal rear wing is, as shown, angled upwardly as it progresses to the rearward. Accordingly, when the horizontal rear wing 400 combined with the combination portion 340 is raised upwardly, drag is produced with respect to the progressive direction of the body and a lift is generated.

By this structure, the horizontal rear wing 400 rotates with respect to the plane P of the body D. With reference to FIG. 3, the horizontal rear wing 400 rotates with respect to the plane P of the body according to the operation of the servo motor in the holder 200.

Since the horizontal rear wing 400 rotates with respect to the plane of the body, the fast and stable turning of the flight is possible.

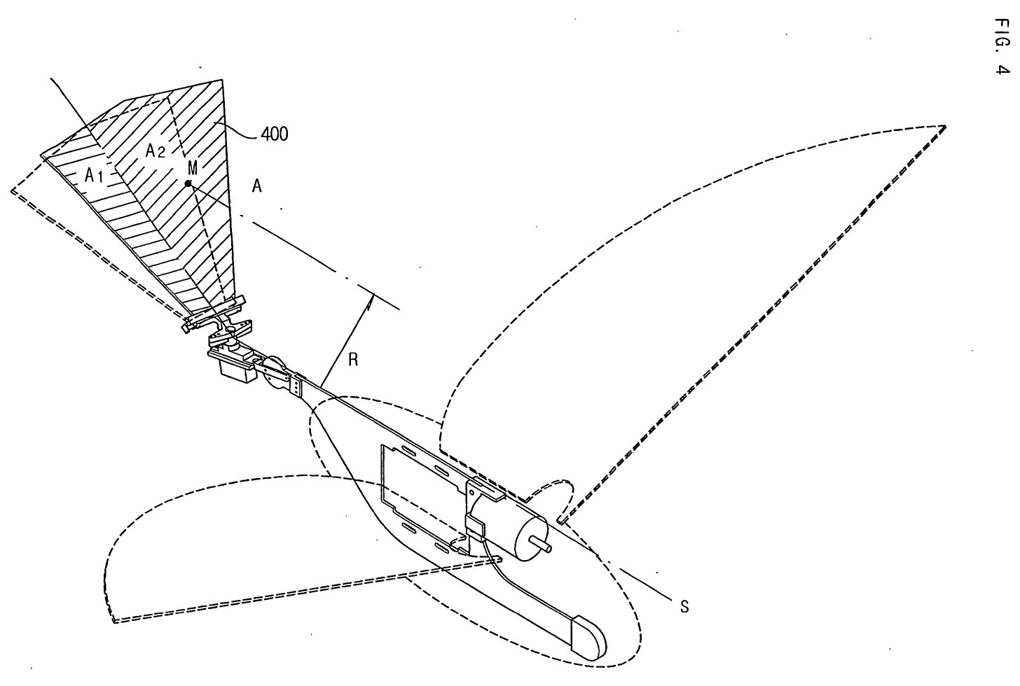

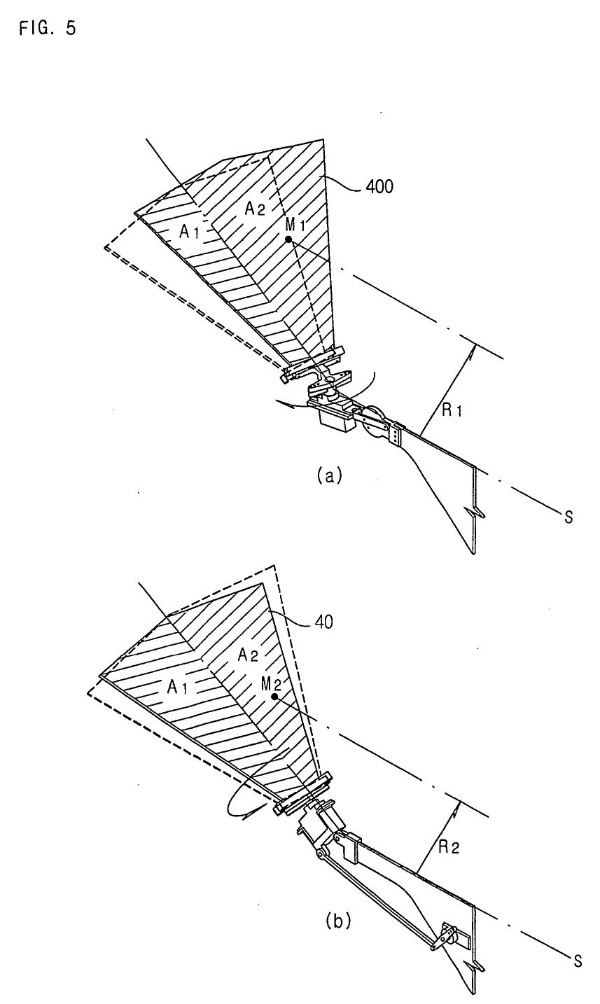

With respect to the FIG. 4, when the servo motor operates by the control of the remote controller and the rear wing 400 rotates with respect to the plane P of the body, there occurs unbalance of area on the rear wing 400 with respect to the central axis S of the body. As the horizontal rear wing 400 turns, one deviated area A 2 on the horizontal rear wing from the central axis S of the body is larger than the other deviated area A 1 on the horizontal rear wing on the opposed direction from the central axis S of the body. Also, distances R from the central axis S of the body to the points on which the drags are applied are different from each other. Accordingly, the flight turns. At this time, as shown in FIG. 5, the deviated area A2 is larger and the distance R is largely increased.

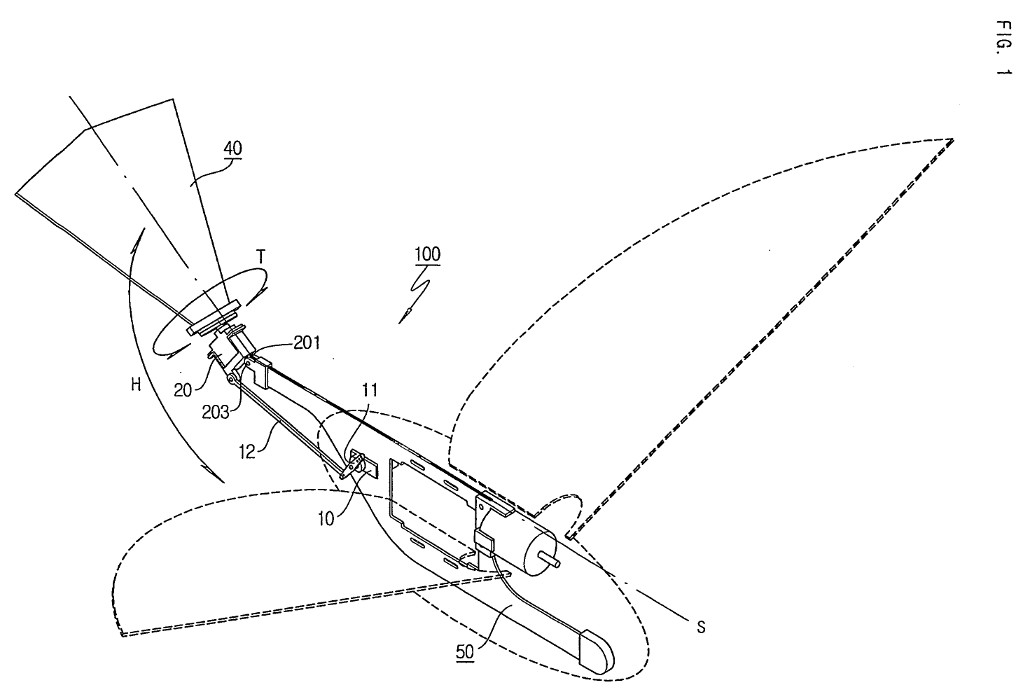

FIG. 5(b) shows a case in which a horizontal rear wing rotates with respect to the central axis of the flight body as shown in FIG. 1. In this case, if a servo motor connected to the horizontal rear wing operates, the difference of drag areas on the right and left is much smaller than that of the present invention as shown in FIG. 5(a). Also, distance R2 to a sectional moment M of the deviated area A2 is smaller than R1 according to the present invention shown FIG. 5(a).

After all, according to the present invention, as the horizontal rear wing rotates with respect to the plane of the body, the deviated area A2 becomes larger than that of the conventional case and the distance R2 from the central axis of the body to the point on which the drag is applied is largely increased compared with the conventional case. As a result, the moment with respect to the central axis becomes much larger and, accordingly, the flight achieves fast turning. Also, according to the present invention, although there is some of the falling of the altitude due to the reduction of the drag against the progressive direction of the flight caused by the rotation of the horizontal rear wing, the falling of the altitude while the flight is turing is very minimal because the turning speed of the flight is very fast. Therefore, the present invention assures the fast and stable turning of the flight.

Although it is possible to control the altitude of the flight by controlling an angle of elevation of the horizontal rear wing, it is also possible to secure the horizontal rear wing 400 to the panel 500 in connection with the angle of elevation. If the angle of elevation of the horizontal rear wing is fixed, skill for controlling the altitude of the flight becomes unnecessary and a novice easily control the flight. In this case, the control of the altitude of the ornithopter type flight is accomplished through the control of the flapping speed of the main wings.

With reference to FIG. 2, the servomotor holder 200 connected with the horizontal rear wing 400 is connected with the panel 500 by means of a first connection 180 and a second connection 160. The second connection 160 includes plates 168 and 169 forked therefrom and, between the plates 168 and 169, the rear part of the panel 500 is mounted. The first connection 180 is combined with the servo motor holder 200 and is hinged to the second connection 160 on a point 184. The first connection 180 includes a hinged connecting part the front part of which is split like a fork and a head of the second connection 160 is mounted between the split space of the hinged connecting part. Then, screws are put through corresponding screw holes 184 and 164 formed on the hinged connecting part and the head of the second connection 160, respectively so that the first connection 180 is hinged to the second connection 160.

The first connection 180 includes a fixing-screw hole 182 and the second connection 160 includes corresponding screw holes 162, 162′ and 162″ formed along a track generated when the first connection 180 circles with respect to the hinge point 184. The screw is released from the screw holes 182 and 162″ on the location as shown in circle A of FIG. 2, and the first connection is circled with respect to the second connection 160 to some degree of angle until the screw hole 182 corresponds with the screw hole 162. Then, the screw is put into the corresponding screw holes 182 and 162 as shown in circle B of FIG. 2. Like this way, it is possible to adjust a combination angle of the first and second connection 180 and 160.

The adjustment of the a combination angle of the first and second connection 180 and 160 means the adjustment of the degree of raise of the horizontal rear wing 400 and leads to the adjustment of the lift of the flight.

### INDUSTRIAL APPLICABILITY

As described above, the present invention provides a horizontal rear wing structure of remote controlled flight assuring fast and stable turning by which a novice can easily and stably control the turning of the flight. Accordingly, it is understood that the purpose of the present invention is accomplished. The present invention is described with reference to the specific embodiments, but the invention is not limited there to. Only the following claims will determine the scope of the invention.

What is claimed is:

1. In a remote controlled flight, the flight comprising:
(a) a panel provided within a body of the flight;
(b) a servo motor mounted on the panel;
(c) a horizontal rear wing; and
(d) a connection for plane-rotation arranged between the servo motor and the horizontal rear wing for rotating the horizontal rear wing with respect to the plane of the body according to the operation of the servo motor.

2. A remote controlled flight as recited in claim 1, in which the connection for plane-rotation comprises:
(a) a rotating member mounted on the servo motor facing the upper side of the body; and
(b) a connecting part mounted on the top side of the rotating member, the connecting part being combined with the horizontal rear wing.

3. A remote controlled flight as recited in claim 2, wherein the servo motor is arranged to face the upper side of the body in the rear part of the panel and the rotating member is directly mounted on a rotating shaft of the servo motor.

4. A remote controlled flight as recited in claim 2 or 3, in which the connecting part comprises:
(a) a combination portion with the horizontal rear wing to be combined with the horizontal rear wing;
(b) a combination portion with the rotating member to be combined with the rotating member; and
(c) a connecting portion connecting the combination portion with the horizontal rear wing and combination portion with the rotating member; wherein,
(d) the combination portion with the horizontal rear wing is angled upwardly as it progresses to the rearward so that the horizontal rear wing combined is raised upwardly.

5. A remote controlled flight as recited in claim 3, further comprising:
(a) a holder for the servo motor;
(b) a first connection including a hinged connection portion and a fixing screw hole, the first connection combined with the holder for the servo motor; and
(c) a second connection combined with the panel, the second connection being hinged to the first connection on the hinged connection portion of the first connection and including corresponding screw holes formed along a track of the fixing screw hole generated when the first connection circles with respect to the hinged connection portion.

6. A remote controlled flight as recited in claim 1, 2, 3 or 5, wherein the remote controlled flight is an ornithopter type flight.

7. A remote controlled flight as recited in claim 4, wherein the remote controlled flight is an ornithopter type flight.
